(19) United States
(12) Patent Application Publication
(10) Pub. No.: US 2014/0205242 A1
(43) Pub. Date: Jul. 24, 2014

(54) OPTICAL MODULE ASSEMBLY WITH CONNECTING MECHANISM

(71) Applicant: HON HAI PRECISION INDUSTRY CO., LTD., New Taipei (TW)

(72) Inventors: GENN-SHENG LEE, New Taipei (TW); JIA-HAU LIU, New Taipei (TW)

(73) Assignee: HON HAI PRECISION INDUSTRY CO., LTD., New Taipei (TW)

(21) Appl. No.: 14/161,585

(22) Filed: Jan. 22, 2014

(30) Foreign Application Priority Data
Jan. 22, 2013 (TW) 102102292

(51) Int. Cl. G02B 6/38

(52) U.S. Cl. CPC G02B 6/381
USPC 385/72

(57) ABSTRACT

An optical module assembly comprises a first optical module and a second optical module engaged with the first optical module. Each of the first and second optical modules comprises a ferrule comprising a first planar surface, a second surface opposite to the first planar surface and at least one connecting mechanism exposed on the second surface of the ferrule, an optical waveguide mounted on the first planar surface of the ferrule, a light guide device coupling to the optical waveguide and disposed on the ferrule, an optical signal transmitted between the first planar surface and the second surface through the light guide device; and wherein the first optical module can be connected with the second optical module by the connecting mechanisms for increasing the transmitting distance of the optical signal.

### BACKGROUND OF THE INVENTION

1. Field of the Invention

The present invention generally relates to an optical module assembly, and more particularly to a connecting mechanism.

2. Description of Related Art

With the rapid development of modern science and technology, an optical waveguide is used as a medium for transmitting optical signal in more and more fields. However, certain considerations such as process technologies, material properties, etc., lead to limited selections on the length of the optical waveguide. Therefore, it is needed to use other components to achieve the connection of multiple optical waveguides with an ultimately desired length.

U.S. Pat. No. 7,212,698, issued on May 1, 2007, discloses an optical module assembly including a PCB having a first surface and an opposite second surface, plural optical waveguides located on the PCB, and a plurality of lenses for coupling an optical signal transmitted through the optical waveguides from the first surface to the second surface. The lenses have a plurality of staggered reflectors disposed on the first surface and a plurality of staggered convex lenses disposed on the second surface. The design aims at decreasing the spacing between waveguides, thereby increasing waveguide density.

In view of the above, a new optical module assembly that overcomes the above-mentioned disadvantages is desired.

### SUMMARY OF THE INVENTION

Accordingly, an object of the present invention is to provide optical module assembly having a simple configuration, an easy assembling process and low cost.

In order to achieve the object set forth, an optical module assembly comprises a first optical module and a second optical module. The first optical module comprises a first ferrule comprising a first planar surface, a second surface opposite to the first planar surface and at least one first connecting mechanism exposed on the second surface of the first ferrule, a first optical waveguide mounted on the first planar surface, and a first light guide device coupling to the first optical waveguide and disposed on the first ferrule. The second optical module comprises a second ferrule including a third planar surface, a fourth surface opposite to the third planar surface and at least one second connecting mechanism exposed on the fourth surface of the second ferrule, a second optical waveguide mounted on the third planar surface, and a second light guide device coupling to the corresponding second optical waveguide and disposed on the second ferrule, an optical signal transmitted between the first optical module and the second optical module by the first and second light guide device. And wherein the first optical module is engaged with the second optical module by the first and second connecting mechanisms mating with each other for transmitting an optical signal between the first optical module and the second optical module by the first and second light guide device.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an optical module assembly in accordance with the present invention;

FIG. 2 is a partially exploded view of the optical module assembly of FIG. 1;

FIG. 3 is an exploded view of the optical module assembly as shown in FIG. 1;

FIG. 4 is a view similar to FIG. 3, but from another perspective;

FIG. 5 is a cross sectional view of the optical module assembly of FIG. 1 taken along line 5-5; and

FIG. 6 is a partially enlarged view of the circled portion in FIG. 5.

### DETAILED DESCRIPTION OF THE INVENTION

Reference will now be made in detail to the preferred embodiment of the present invention.

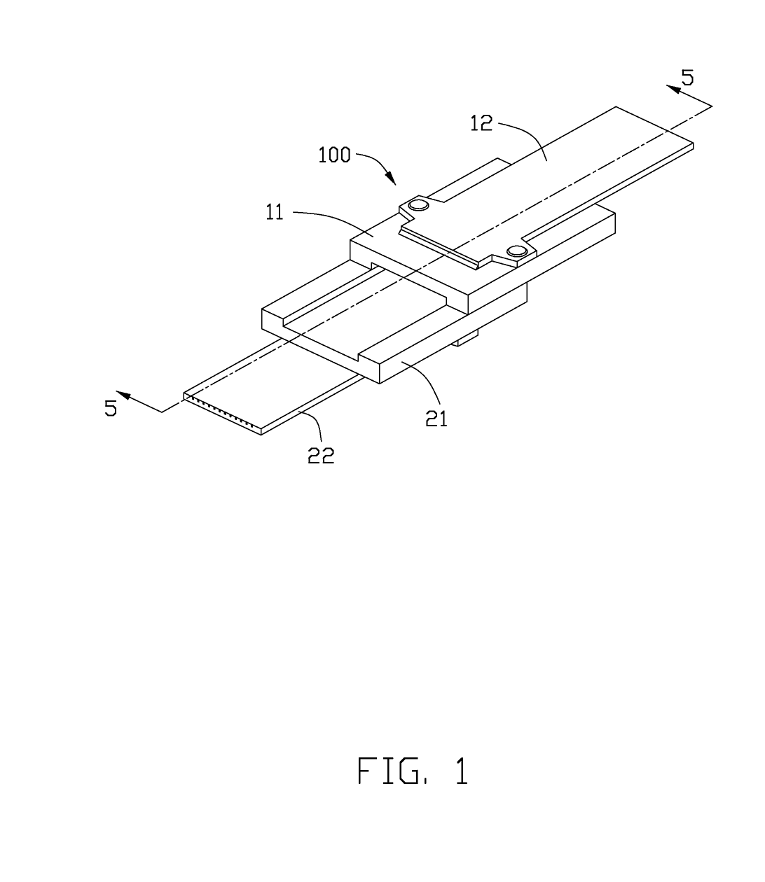

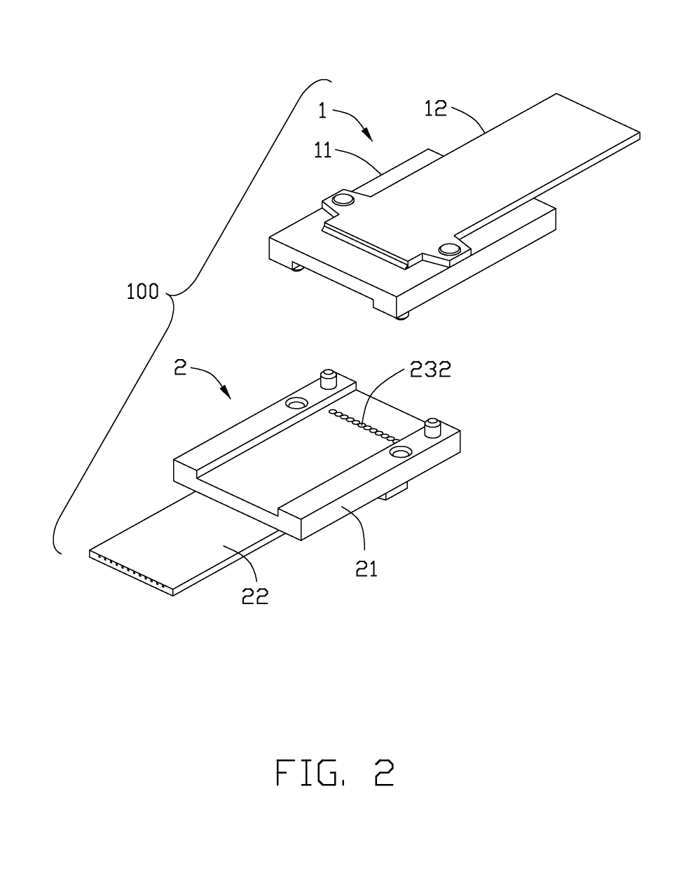

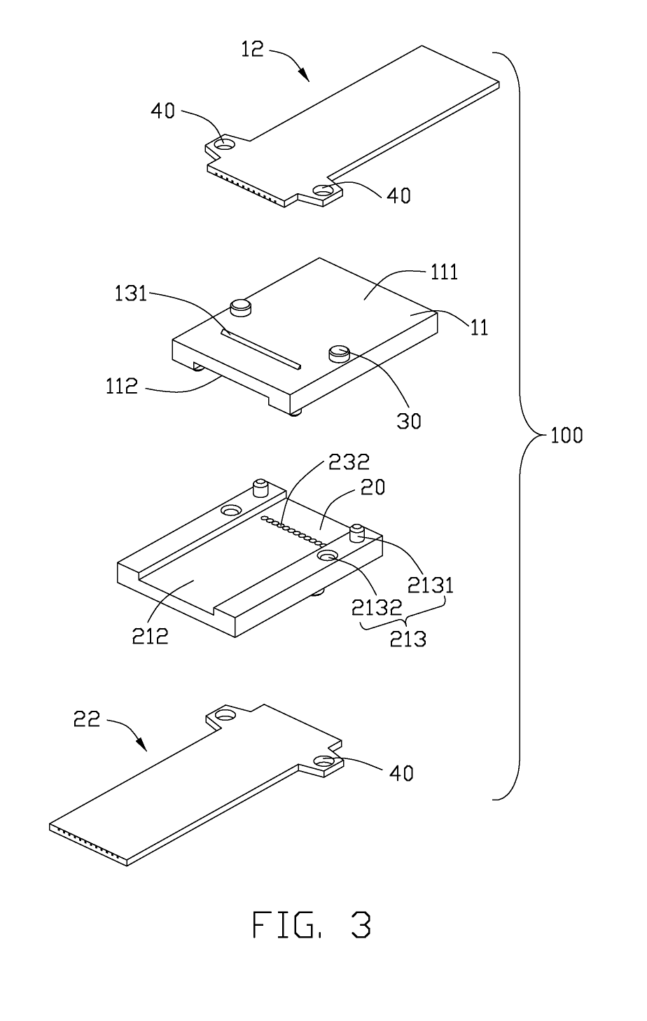

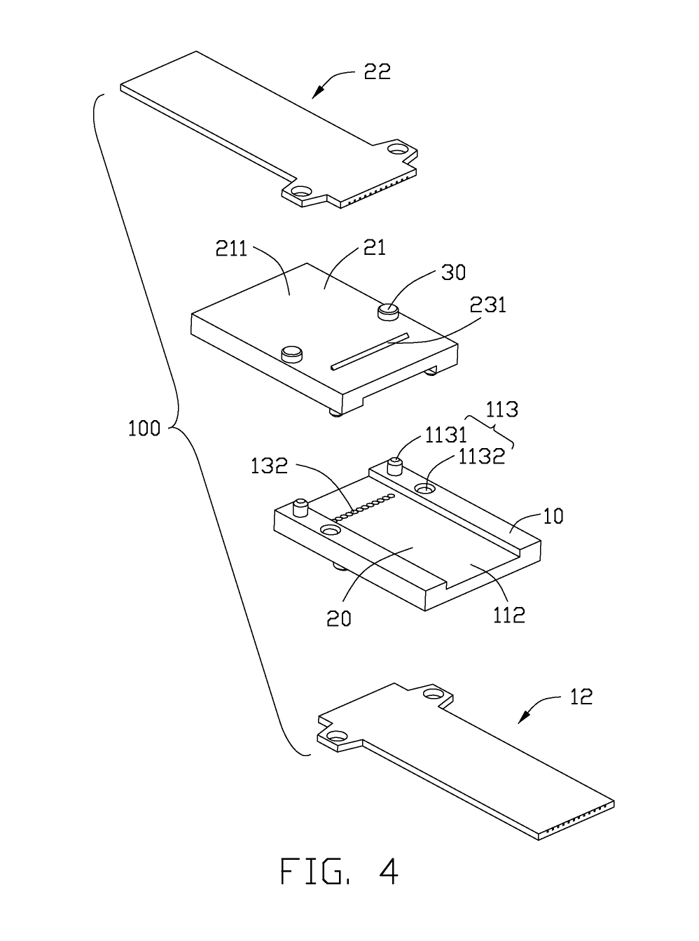

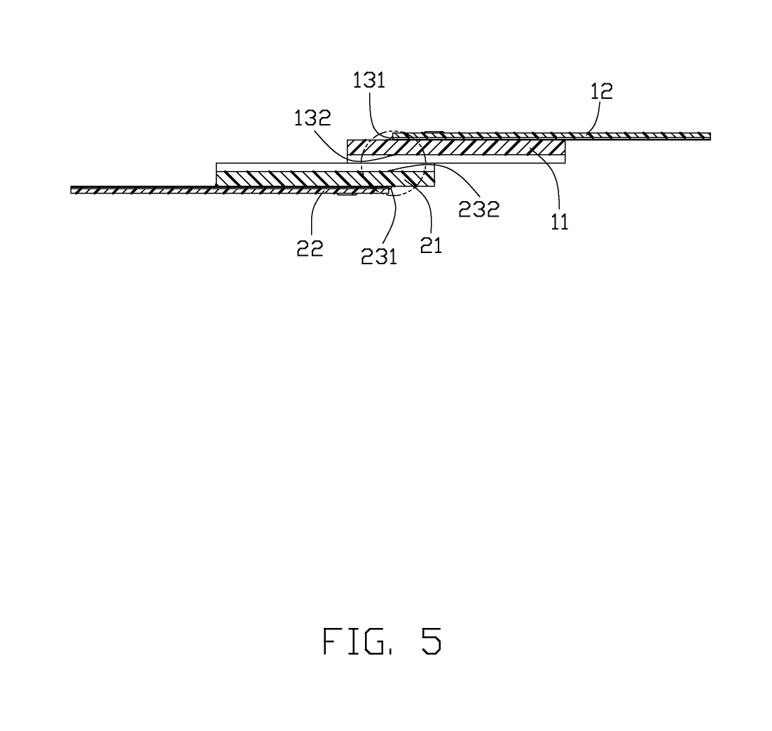

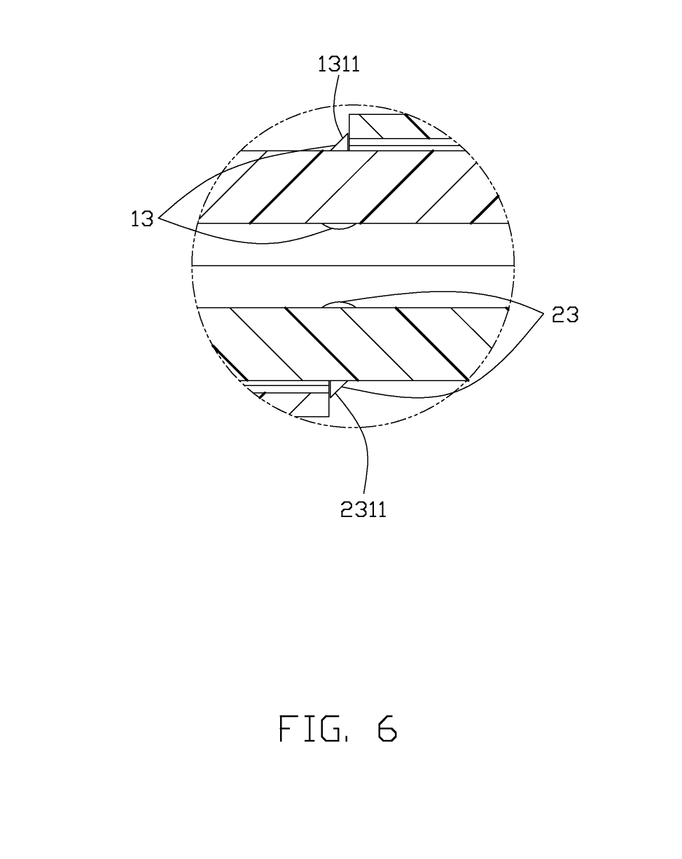

Referring to FIGS. 1-6, an optical module assembly 100 in accordance with the present invention comprises a first optical module 1 and a second optical module 2 engaged with the first optical module 1. The first optical module 1 comprises a first ferrule 11, a first optical waveguide 12 mounted on the first ferrule 11, and a first light guide device 13 coupling to the first optical waveguide 12 and disposed on the first ferrule 11. The second optical module 2 comprises a second ferrule 21, a second optical waveguide 22 mounted on the second ferrule 21, a second light guide device 23 coupling to the second optical waveguide 22 and disposed on the second ferrule 21. The first ferrule 11 and the second ferrule 21 have the same configuration. An optical signal is transmitted between the first ferrule 11 and the second ferrule 21 by the first and second light guide devices 13, 23. The first optical module 1 and the second optical module 2 have the same configuration. When the first optical module 1 is connected with the second optical module 2, the second optical module 2 arranged below the first optical module 1, and the first optical module 1 and the second module 2 are at least partially overlapped in the vertical direction. In this embodiment, due to the first optical module 1 and the second optical module 2 having the same configuration, it is only need to produce a kind of optical module. Thus it will greatly save the cost. Note that the exemplary embodiments discussed herein refer to two optical modules. This approach is preferred, however, in some instances, the optical module assembly 100 can have three, four or more optical modules in order to increase the transmitting distance of the optical signal and meet demand.

The first ferrule 11 includes a first planar surface 111, a second surface 112 opposite to the first planar surface 111, and at least one first connecting mechanism 113 exposed on the second surface 112. The second ferrule 21 includes a third planar surface 211, a fourth surface 212 opposite to the third planar surface 211, and at least one second connecting mechanism 213 exposed on the fourth surface 212. Each of first and second ferrules 11, 21 comprise a pair of flanges 10 extending outwardly from two lateral sides of the corresponding second and fourth surface 112, 212, a receiving passage 20 formed between the two flanges 10 and disposed on the corresponding second and fourth surfaces 112, 212, respectively, and a pair of first posts 30 extending outwardly from the corresponding first and third planar surface 111, 211. And both of the first and second optical waveguides 12, 22 comprise a pair of mounting holes 40 for mating with the corresponding first posts 30 for precisely and accurately positioning the first and second optical waveguides 12, 22. The first and second optical waveguides 12, 22 are manufactured by polymer material. Compared to the prior art, it is not need to increase the tolerance level of the overall width of the optical waveguide and it is easier to manufacture.

In this embodiment, there are two first connecting mechanisms 113 located on the corresponding flanges 10 of the first ferrule 11, and there are two second connecting mechanisms 213 located on the corresponding flanges 10 of the second ferrule 21. In some instances, each of the first and second optical modules can have one or three and even more connecting mechanisms. Each of the first connecting mechanisms 113 comprises a second post 1131 and a first recess 1132 spaced apart from the second post 1131 in a front-to-back direction, and each of the second connecting mechanisms 213 comprises a third post 2131 and a second recess 2132 spaced apart from the third post 2131 in a front-to-back direction. When the first optical module 1 is engaged with the second optical module 2, the second post 1131 of the first mechanism 113 mated with the second recess 2132 of the second mechanism 213, the first recess 1132 of the first mechanism 113 mated with the third post 2131 of the second mechanism 213. Such design not only increasing the transmitting distance of the optical signal, but also the process of connection is simple.

The first guide device 13 of the first optical module 1 includes a first reflector 131 protruded out of the first planar surface 111 of the first ferrule 11, a first convex lens array 132 protruded out of the second surface 112 of the first ferrule 11. And the second light guide device 23 of the second optical module 2 includes a second reflector 231 protruded out of the third planar surface 211 of the second ferrule 21, and the second convex lens array 232 protruded out of the fourth surface 212 of the second ferrule 21. The first reflector 131 has an incident surface 1311 used for changing the transmitting direction of the optical signal and transmitting into the first convex lens array 132. An angle is formed between the incident surface 1311 of the first reflector 131 and the first planar surface 111. The second reflector 231 has an output surface 2311 used for outputting the optical signal. An incident light forwardly coming out from the first optical waveguide 12 and parallel to the first planar surface 111 of the first ferrule 11 is firstly reflected by the incident surface 1311 of the first reflector 131 downwardly, and secondly focused by the first convex lens array 132, then entering the second optical module 2 and being focused by the second convex lens array 232, and thirdly reflected by the output surface 2311 of the second reflector 231. It could reduce the loss of the light in the transmission by the first and second convex lens arrays. When the first optical module 1 is connected with the second optical module 2, the second surface 112 of the first ferrule 11 mated with fourth surface 212 of the second ferrule 21. A space is formed by the receiving passage 20 disposed on the first ferrule 11 and the second ferrule 21 for receiving the first and second lens array 132, 232.

It is to be understood, however, that even though numerous characteristics and advantages of the present invention have been set forth in the foregoing description, together with details of the structure and function of the invention, the disclosure is illustrated only, and changes may be made in detail, especially in matters of shape, size, and arrangement of parts within the principles of the invention to the full extent indicated by the broad general meaning of the terms in which the appended claims are expressed.

What is claimed is:

1. An optical module comprising:
a ferrule comprising a first planar surface, an opposite second surface, a pair of first posts extending outwardly from the first planar surface, a pair of flanges extending outwardly from two lateral sides of the second surface, a pair of second posts exposed on the flanges, a pair of recesses located on the flanges and spaced apart from the second posts in a front-to-back direction;
an optical waveguide comprising a pair of mounting holes mating with the first posts for positioning the optical waveguide on the first planar surface; and
a light guide device disposed on the ferrule for coupling an optical signal transmitted through the optical waveguide from the first planar surface to the second surface.

2. The optical module as claimed in claim 2, wherein the light guide device comprises a reflector protruding out of the first planar surface of the ferrule and a convex lens array protruding out of the second surface of the ferrule, and the reflector has an incident surface for receiving the optical signal.

3. The optical module as claimed in claim 2, wherein an angle is formed between the incident surface of the reflector and the first planar surface.

4. The optical module as claimed in claim 2, wherein an incident light forwardly coming out from the optical waveguide and parallel to the first planar surface of the ferrule is firstly reflected by the incident surface of the reflector downwardly and then focused by the convex lens array.

5. The optical module as claimed in claim 2, wherein the ferrule comprises a receiving passage formed between the two flanges on the second surface and extending along the front-to-back direction, and the convex lens array is exposed on the receiving passage.

6. An optical module assembly comprising:
a first optical module comprising:
a first ferrule including a first planar surface, an opposite second surface, and at least one first connecting mechanism exposed on the second surface,
a first optical waveguide mounted on the first planar surface, and
a first light guide device disposed on the first ferrule for coupling to the first optical waveguide; and
a second optical module comprising:
a second ferrule including a third planar surface, an opposite fourth surface, and at least one second connecting mechanism exposed on the fourth surface,
a second optical waveguide mounted on the third planar surface, and
a second light guide device disposed on the second ferrule for coupling to the corresponding second optical waveguide;
wherein the first optical module is engaged with the second optical module by the first and second connecting mechanisms mating with each other for transmitting an optical signal between the first optical module and the second optical module by the first and second light guide device.

7. The optical module assembly as claimed in claim 6, wherein each of the first and second ferrules comprises a pair of first posts extending outwardly from the corresponding first and third planar surfaces, and each of the first and second optical waveguides comprises a pair of mounting holes mating with corresponding first posts.

8. The optical module assembly as claimed in claim 6, wherein the first light guide device comprises a first reflector protruding out of the first planar surface and a first convex lens array protruding out of the second surface, the second light guide device comprises a second reflector protruding out of the third planar surface and a second convex lens array protruding out of the fourth surface, and the transmitting direction of the optical signal is changed by an incident surface of the first reflector to transmit onto the first convex lens array and then to being focused by the second convex lens array to transmit onto an output surface of the second reflector.

9. The optical module assembly as claimed in claim 6, wherein each of the first and second ferrules comprises plural receiving passages disposed on corresponding second and fourth surfaces and extending along a front-to-back direction, and the first and second convex lens arrays are exposed on corresponding receiving passages, respectively.

10. The optical module assembly as claimed in claim 6, wherein each of the first connecting mechanisms comprises a second post and a first recess spaced apart from the second post in a front-to-back direction and disposed on the second surface, and each of the second connecting mechanisms comprises a third post and a second recess spaced apart from the third post in the front-to-back direction and disposed on the fourth surface, the second post of the first connecting mechanism mated with the second recess of the second mechanism, the first recess of the first connecting mechanism mated with the third post of the second connecting mechanism.

11. The optical module assembly as claimed in claim 6, wherein the second surface of the first optical module is mated with the fourth surface of the second optical module, and the first optical module and the second optical module are at least partially overlapped in the vertical direction.

12. The optical module assembly as claimed in claim 6, wherein the first and second optical waveguides are manufactured by polymer material.

13. An optical module assembly comprising:
first and second optical modules oppositely symmetrically assembled with each other in a vertical direction,
the first module defines a first ferrule defining opposite first interior and first exterior surfaces thereon, a first optical waveguide assembled upon the first exterior surface, and a first light guide device extending through said first ferrule with opposite ends exposed on the opposite first exterior and interior surfaces thereof; and
the second module defines a first ferrule defining opposite second interior and second exterior surfaces thereon, a second optical waveguide assembled upon the second exterior surface, and a second light guide device extending through said second ferrule with opposite ends exposed on the opposite second exterior and interior surfaces thereof; wherein
the first ferrule and the second ferrule are symmetrically arrange with each other with the first interior surface and the second interior surface intimately facing each other, the first light guide device and the second light guide device are aligned with each other in said vertical direction, the first light guide device is aligned with the first optical waveguide in a lengthwise direction perpendicular to said vertical direction, and the second light guide device is aligned with the second optical waveguide in the lengthwise direction.

14. The optical module assembly as claimed in claim 13, wherein the first and second optical modules are oppositely arranged with each other in both the vertical direction and the lengthwise direction.

15. The optical module assembly as claimed in claim 13, wherein said first optical module and said second optical module are essentially identical to each other.

16. The optical module assembly as claimed in claim 13, wherein said first ferrule defines a plurality of positioning posts on both said first interior and exterior surfaces, and said second ferrule defines a plurality of positioning posts on both said second interior and exterior surfaces.

17. The optical module assembly as claimed in claim 13, wherein said first ferrule defines a plurality of posts and holes around the first interior surface to couple to corresponding holes and posts around the second interior surface of the second ferrule.

18. The optical module assembly as claimed in claim 13, wherein each of said first and second ferrules defines a recessed area around the corresponding interior surface so as to form a space between the assembled first and second ferrules.

19. The optical module assembly as claimed in claim 13, wherein each of said first and second light guide devices is spanned in a transverse direction perpendicular to both said vertical direction and said lengthwise direction.

20. The optical module assembly as claimed in claim 13, wherein each of said light guide device defines a reflector array around the corresponding exterior surface and a lens array around the interior surface.
